(19) United States
(12) Patent Application Publication
(10) Pub. No.: US 2011/0029331 A1
(43) Pub. Date: Feb. 3, 2011

(54) METHOD OF PROCESSING STRUCTURE DAMAGE INSURANCE CLAIMS

(76) Inventors: Bart Parker, Ball Ground, GA (US); Kevin Loner, Ball Ground, GA (US)

Correspondence Address: SEYFARTH SHAW LLP, WORLD TRADE CENTER EAST, TWO SEAPORT LANE, SUITE 300, BOSTON, MA, 02210-2028, US

(21) Appl. No.: 12/534,483

(22) Filed: Aug. 3, 2009

(51) Int. Cl. G06Q 40/00

(52) U.S. Cl. 705/4

(57) ABSTRACT

A method of processing insurance claims with respect to a damaged structure, not requiring the removal of protective covering to view and inspect the damaged structure, and in particular an area of damage on the damaged structure, is disclosed. The method is facilitated by the use of a tarp having at least a transparent portion characterized by high durability and clarity provided in a size appropriate to enclose the area of damage, the tarp covering the area of damage on the damaged structure. Due to the tarp's transparency, an insurance provider assessor may view the damaged structure and inspect the structure and area of damage through the tarp without removal of the tarp.

### TECHNICAL FIELD OF THE INVENTION

The present invention relates to a method of processing insurance claims directed to damaged structures.

### BACKGROUND OF THE INVENTION

As urban and residential areas become more densely populated, and new construction of housing, commercial, and other structures increases with each passing year, the need for improving the efficiency and speed with which responders may tend to houses and other structures affected by inclement weather conditions grows ever-more important. As tragic circumstances along the Gulf Coast and other regions prone to severe weather conditions have recently demonstrated, large populations of residents, commercial enterprises, social services, and government operations are being affected by weather events, such as hurricanes, as never before.

The large-scale consequences of a severe weather event to home and business owners has created high demand for methods of increasing the speed with which assessment of the damage and reconstruction can occur after such a devastating occurrence. Particularly in regions where thousands of properties may be damaged, or obliterated, by a single occurrence of a hurricane, tornado, tsunami, earthquake, fire, or other destructive force, the time and expertise of a few key experts—such as insurance assessors—must be optimized to quickly and effectively provide services to each victim and their property. Specific to the filing of insurance claims, the protracted assessment process by which insurance representatives must evaluate the structural damage to a claimant's investments further compounds the economic and emotional toll on persons affected by such disasters.

The process of recovering from a disaster is further complicated by the practice of tarping, i.e. covering with a tarp or protective sheeting, a damaged structure to prevent further degradation caused by continued rainfall, vermin infestation, blowing of dirt and storm debris. In particular, the tarps presently available for protecting damaged structures require the process of tarping to occur immediately after the structure is damaged. This frequently requires removal of the tarp to permit entry and evaluation by an insurance assessor, and retarping to prevent further damage between the assessment and reconstruction of the structure. This process is generally necessitated by the use of colored tarps, including white or blue tarps, that are desirable for their qualities of strength, resiliency, and light-reflection.

However, the redundant process of tarping and retarping a damaged structure is tiring, time-consuming, and costly for persons hiring third parties to properly tarp the property. Retarping also requires coordination by the third-party-tarpers, insurance assessors, and structure owners, to ensure each step is conducted in the appropriate order, and without allowing considerable time to elapse between any of the steps. Even a small misstep in this coordination can permit further degradation of the property, or an incorrect or incomplete assessment of the actual damage to the structure.

### SUMMARY OF THE INVENTION

The present invention provides a method for processing insurance claims arising from damage caused by severe weather conditions, or other forces causing destruction or degradation to a structure, in which the structure may be protected from further degradation by avoiding the need to remove protective tarps while still enabling an insurance assessor to efficiently evaluate the damage. Accordingly, there is disclosed and claimed herein an improved method by which an assessor may process an insurance claim for a damaged structure, thereby providing quicker and more accurate insurance services, which avoids the disadvantages of prior methods while affording additional advantages.

In one embodiment of the claimed method, a damaged area of a damaged structure may be covered with a transparent tarp, the tarp or transparent area being sized to correspond to the area of damage. A further aspect of one embodiment comprises an insurance provider-assessor viewing the damaged structure and inspecting the damaged structure—and particularly the area of damage—without removing the transparent tarp.

Another aspect of an embodiment of the claimed method is securing the transparent tarp to the structure through use of affixing mechanisms. In one embodiment, the affixing mechanisms may include planks including nails having been driven through the planks and transparent tarp and into the structure. An additional embodiment includes affixing mechanisms comprising grommets provided in the transparent tarp, one or more ropes, elastic cords, chains or the like in combination with the grommets, securing the transparent tarp to the structure.

It is yet a further aspect of an embodiment of the claimed method that the structure is equipped with mechanisms in coordination with the transparent tarp to promote circulation of air in the damaged structure. In an embodiment, the mechanism for promoting air circulation may comprise one or more vents disposed in conjunction with the tarp.

Finally, an aspect of one embodiment of the claimed method includes providing the transparent tarp with reinforced hems to further strengthen the transparent tarp for durability. In one embodiment of the claimed method, the transparent tarp may be custom manufactured according to the dimensions of the area of damage and the structure, itself. In an alternative embodiment of the claimed method, the transparent tarp may be selected from a catalogue of prefabricated transparent tarps according to the dimensions of the area of damage and structure.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected and many of its advantages should be readily understood and appreciated.

FIG. 1 is a flow chart detailing one embodiment of the method of processing structure damage insurance claims;

FIG. 2 is a flow chart detailing an additional embodiment of the method of processing structure damage insurance claims in accordance with the claimed invention; and

FIG. 3 is an illustration of one possible embodiment of the claimed method of processing structure damage insurance claims as implemented.

### DETAILED DESCRIPTION

While this invention is susceptible of embodiments in many different forms, there is shown in the drawings and will herein be described in detail an illustrative embodiment of the invention with the understanding that the present disclosure is to be considered as an exemplification of the principles of the invention and is not intended to limit the broad aspect of the invention to embodiments illustrated.

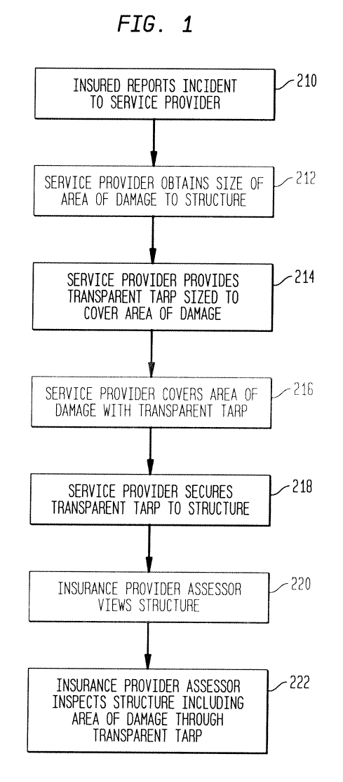

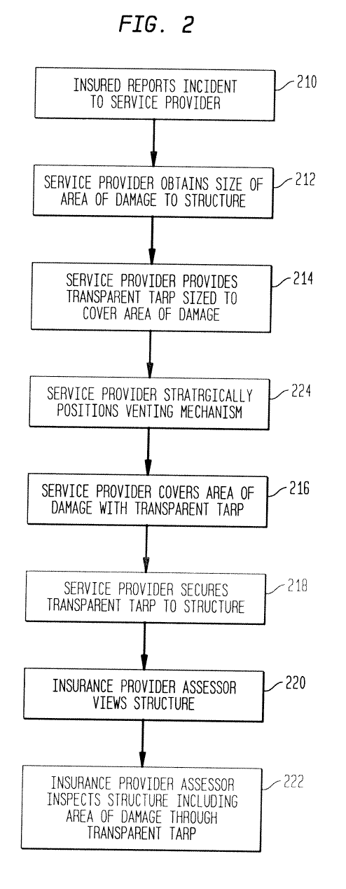

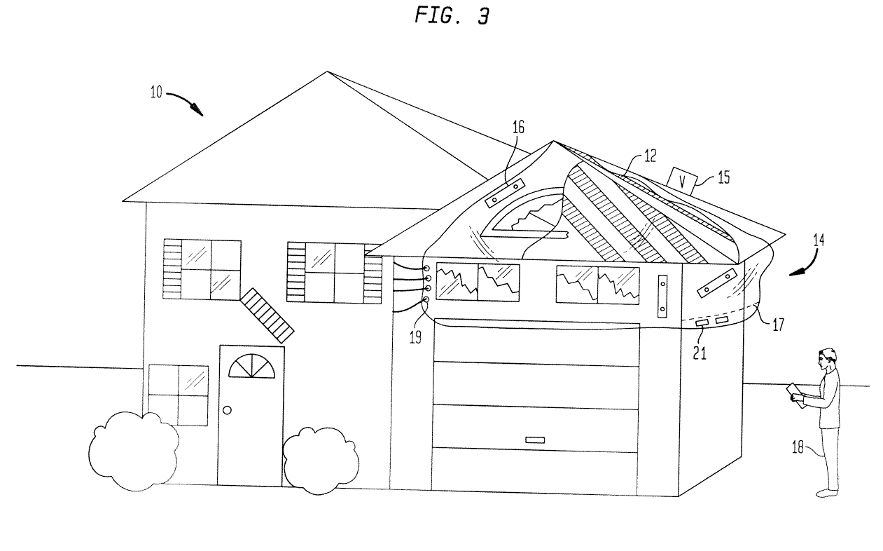

Referring to FIGS. 1 and 2, there is illustrated a method of processing insurance claims directed to structural damage of an insured property while preserving the remaining integrity of the structure. FIG. 3 depicts one circumstance in which the disclosed method may be implemented in processing an insurance claim. As detailed in the flowchart of FIG. 1, the method generally is initiated upon the report 210 of structural damage to insured property, such as a house or other building, by the insured to a service provider. The service provider may be an institution or person having expertise in the field of disaster recovery, such as preservation or reconstruction of a building following damage caused by a hurricane, tornado, earthquake, fire, termite infestation, tsunami, or other such instance jeopardizing the integrity of the building's structure or foundation.

Following receipt of the incident report 210, the service provider may then obtain the size of the area of damage 212 to the structure, the structure generally designated by the reference number 10, as illustrated in FIG. 3. The service provider may either receive the dimensions of the area of damage 12 from the person reporting the damage, or may alternatively perform an on-site assessment of the area of damage 12 with respect to the relevant structure 10. After obtaining the size of the area of damage 12, the service provider then may either fabricate a custom transparent protective covering, such as the transparent tarp 14 illustrated in FIG. 3, or may select the most appropriate of pre-fabricated transparent tarps for the size of the subject area of damage 12. For example, where the tarp will be used to protect a roof having an unusual shape or with a particularly steep pitch, it may be desirable to customize the tarp to the specific dimensions of the structure for a secure fit. For a more standard roof design, or for protecting a flat side-surface, however, the use of one of a standard selection of transparent tarps may be more economical and efficient.

As is known in the art, tarps may be manufactured in a variety of colors, weaves, and thicknesses, and of a variety of materials. One embodiment of the tarp to be used in the presently disclosed method is a transparent tarp with a high level of clarity, the importance of which will be described in greater detail below. The appropriate thickness of the tarp may be selected based upon a number of factors, such as the structure to be protected, the length of time over which the tarp must protect the structure from outside elements, the size of the area of damage, and the likelihood and severity of subsequent damaging weather conditions. Generally tarps may be provided in 6-12 mil—the unit of measurement used to describe thickness, where 1 mil is equal to 0.001 inch. For large structures, such as houses or other buildings, that are likely to be subject to additional inclement conditions, a greater thickness of 8.5 mil to 12 mil is desirable in the transparent material.

With respect to the nature of the material itself, polyvinyl, polyethylene, and resin, are frequently used to construct protective coverings such as tarps. It is envisioned, however, that other materials may be similarly utilized if possessing the properties, as appropriate to each application, of being waterproof, transparent, durable, wind resistant, resistant to degradation in particularly high or particularly low temperatures, possible resistant to mildew and acid, and possibly treated to block UV rays. Following the manufacture or selection of the appropriate transparent tarp, the tarp is transported to the damage site and provided 214 to cover the area of damage 12.

FIG. 2 includes the optional step of strategically positioning 224 venting mechanisms (See e.g., FIG. 3, Ref no. 15) in the vicinity of the area of damage 12. As is shown in the illustrative embodiment of FIG. 3, a venting mechanism 15 can be placed to vent through the tarp to facilitate circulation and dehumidification (to an extent), if and as needed at the discretion of the installer. Such functions may be particularly important in the use of protective transparent tarps, such as that claimed in the instant method, because—unlike colored tarps—transparent tarps do not reflect the sun's rays. Accordingly, sunny conditions create a warm and humid atmosphere under a transparent tarp.

Accordingly, the service provider or installer may install one kind of well known venting mechanism, or a combination of several different varieties. For example, disposition of a vent (or one or more vents disposed to facilitate airflow) allows air to pass provide for venting under the protective cover. Such vents may take any form ranging from a simple series of holes cut in the protective cover to a more complicated series of plastic vents installed on the tarp, allowing moisture to escape.

Subsequent to the optional step of venting mechanism placement 224, and to the step of providing the appropriately sized transparent tarp or tarp with a transparent portion 214 with the desirable characteristics depending on cost, length of time for which protection is needed, weather conditions, and any other factors pertinent to the selection of the tarp, the service provider may then cover 216 the area of damage 12 on the structure 10 with the transparent tarp 14. FIG. 3 illustrates the transparent tarp 14 covering the area of damage 12 following this step. Alternatively, a different party, such as the structure-owner or operator, may be the one responsible for completing the step of covering 216 the area of damage 12 with the transparent tarp 14.

Regardless, the party responsible for completing this step 216 should ensure that substantially the entire area of damage 12, and the area immediately surrounding the area of damage 12, is enclosed by the transparent tarp 14, so to prevent the exposed structural supports or inside of the structure from experiencing further degradation due to weather conditions or other possible causes of damage. Even a small vulnerable area not protected by the transparent tarp 14 may jeopardize the remainder of the area of damage 12 and may result in the ultimate destruction of the structure 10.

FIGS. 1 and 2 include the optional step of securing 218 the transparent tarp 14 to the structure 10 with affixing mechanisms 16. The securing step 218 may not always be necessary due to the inherent weight of the tarp itself, however implementing this step 218 may be preferred in areas of high winds or additional rain, to avoid the transparent tarp 14 from being dislodged. FIG. 3 illustrates the affixing mechanisms as being a plank and nail assembly, the nails being driven through the plank and through the transparent tarp and into the structure. Alternatively, or in combination, the affixing mechanisms 16 may comprise other mechanisms, such as a grommet rope assembly 19. In particular, a hem 17 around the perimeter of the transparent tarp 14 may be equipped with grommets, through which one or more ropes may be threaded and then secured to various points about the structure 10. Particularly in this embodiment, it may be beneficial to provide the transparent tarp 14 with a reinforced hem to avoid tearing. Additional affixing means are further envisioned, including weights 21 being provided in the reinforced hem, high strength tape affixed along the tarp's perimeter, or a magnet assembly installed on the structure 10 and the tarp 14.

The benefits provided in steps 210, 212, 214, and 216, and the optional steps of 218 and 224, are evidenced in succeeding steps 220 and 222. In particular, and as illustrated in FIGS. 1-3, the use of the transparent tarp enables an insurance provider assessor 18 to view the structure 10 and inspect the area of damage 12 through the transparent tarp 14. The use of a durable and transparent tarp, or tarp portion, with high clarity is key to this process, obviating the step of removing the tarp as implemented in existing methods of protecting and assessing the insurance value of damaged structures.

Generally, after tarping the damaged structure to protect the area of damage from the elements, the tarp must be removed prior to inspection by the insurance assessor, because colored tarps have traditionally been used. Finally, after the insurance assessment is performed but before reconstruction is completed, the area of damage is retarped. Each step of the traditional tarp installation, take-down, and reinstallation process takes several hours, without even taking into account the additional delays imposed by scheduling or missed appointments. This process may be particularly protracted where there are only a few service providers in a large area severely effected by a destructive weather event required to service the entire population of property owners.

Accordingly, the benefits of tarping the area of damage with a transparent tarp of high clarity but also characterized by high durability are readily apparent. As illustrated in FIG. 3, the insurance provider assessor 18 may perform the inspection 222 of the area of damage 12 according to his or her own schedule, rather than being forced to coordinate with the property owner and the service provider responsible for the tarping process. The durable transparent tarp 14, particularly when equipped with strategically positioned venting mechanism(s) as provided in step 224, still provides the structural protection of existing methods of tarping, but eliminates the extra untarping step that can considerably complicate the reconstruction process.

While the damaged structure illustrated in the present description is a residential house, it is to be understood that the same process may be applied to any structure for which protection is required after an incident of damage before, during, and after the structure is inspected for purposes of processing an insurance claim assessment.

Although the tarp used in the process according to the invention is referred to as a “transparent tarp, it should be appreciated by those skilled in the art that the entire tarp does not need to be transparent, only the section covering the damaged area, so various dimensions or portions of transparent material may be used with an otherwise non-transparent tarp and implemented according to the invention.

Although a venting device is described in the illustrative embodiment and shown as a single vent 15, it should be appreciated that a number of vents may be strategically placed and other varieties of dehumidifying devices well known in the art may be used in combination, such as desiccants (for example bentonite clay, silica gel, magnesium, or potassium carbonate, that absorbs water to remove humidity from the area immediately surrounding the desiccant), and other dehumidifying mechanisms such as blowers, fans, or other device designed to circulate otherwise stagnant air may be used in combination with the venting previously described. Strategic placement of one or more venting mechanisms may be an important tool in avoiding additional structural damage to the property.

The matter set forth in the foregoing description and accompanying figures is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A method of processing an insurance claim for a damaged structure, comprising the steps of:
providing a tarp with at least a transparent portion sized to cover an area of damage on a structure;
covering said area of damage on said structure with said tarp;
viewing said structure by an insurance provider assessor; and
inspecting said structure, including said area of damage on said structure, by said insurance provider assessor viewing said area of damage through said at least a transparent portion of said tarp.

2. The method of claim 1, further comprising the step of strategically positioning one or more venting mechanisms with respect to said structure after said providing step and before said covering step.

3. The method of claim 1, further comprising the step of securing said tarp with said at least a transparent portion to said structure by one or more affixing mechanisms after said covering step and before said viewing step.

4. The method claim of 3, wherein said affixing mechanisms comprise a plank and nail assembly.

5. The method of claim 3, wherein said transparent tarp includes a series of grommets through which one or more ropes may be threaded and secured to a corresponding series of affixing points about said structure.

6. The method of claim 1, wherein said tarp includes a reinforced hem along a perimeter of said tarp.

7. The method of claim 1, wherein said providing step comprises manufacturing a customized transparent tarp according to a set of dimensions specific to said area of damage.

8. The method of claim 1, wherein said providing step comprises selecting one of a set of prefabricated transparent tarps according to a set of dimensions specific to said area of damage.

9. The method for claim 1 wherein said at least a transparent portion of said tarp is the entire tarp.
